(19) United States
(12) Patent Application Publication
(10) Pub. No.: US 2026/0180004 A1
(43) Pub. Date: Jun. 25, 2026

(54) E-CALL SYSTEM COMPRISING A BACK-UP BATTERY

(71) Applicant: Continental Automotive Technologies GmbH, Hannover (DE)

(72) Inventor: Andreas Plach, Forchheim (DE)

(73) Assignee: Continental Automotive Technologies GmbH, Hannover (DE)

(21) Appl. No.: 18/726,451

(22) PCT Filed: Dec. 6, 2022
(86) PCT No.: PCT/EP2022/084641

§ 371 Date: Jul. 3, 2024

(30) Foreign Application Priority Data
Jan. 4, 2022 (DE) 10 2022 200 025.0

(51) Int. Cl. H01M 4/60; B60L 50/64; H01M 10/052; H01M 10/0525

(52) U.S. Cl. CPC H01M 4/606; B60L 50/64; H01M 10/052; H01M 10/0525

(57) ABSTRACT

An eCall-system for a vehicle includes an electronic circuitry arranged for generating an emergency call. The electronic circuitry is attached to a structure. The structure includes an aluminum part. The eCall-system further includes a back-up battery, which is an aluminum type battery and is electrically connected to the electronic circuitry. The aluminum part provides the aluminum electrode for the back-up-battery. The eCall-system includes an antenna unit with a copper part. The copper part provides a copper electrode of the back-up-battery. The electronic circuitry is further arranged for detecting an accident and for generating an emergency call in response to a detected accident.

### CROSS-REFERENCE TO RELATED APPLICATIONS

The present application is a National Stage Application under 35 U.S.C. § 371 of International Patent Application No. PCT/EP 2022/084641 filed on Dec. 6, 2022, and claims priority from German Patent Application No. 10 2022 200 025.0 filed on Jan. 4, 2022, in the German Patent and Trademark Office, the disclosures of which are herein incorporated by reference in their entireties.

### TECHNICAL FIELD

The invention relates to an eCall-system comprising a back-up-battery.

### BACKGROUND

Emergency call systems or eCall systems are devices installed in vehicles that will automatically contact the emergency services in case of an accident. The system may send information about the location and the kind of accident over wireless connection to the emergency services.

In case of an accident, the vehicle main battery or the internal electrical cables connecting the eCall-system with the vehicle main battery may be damaged, which could result in a non-functioning eCall system. To prevent this, an eCall-system may be equipped with a back-up battery. However, back-up-batteries may be heavy. Furthermore, since these batteries may lose or leak some of their stored energy over time, an additional capacity is required to compensate for this loss, and this adds extra weight.

### BRIEF SUMMARY

The objective of the invention is to provide an eCall-system with a reduced weight.

The objective of the invention is met by providing an eCall-system according to the independent claim.

According to a first aspect, an eCall-system for a vehicle is provided comprising:
a structure comprising an aluminum part;
an electronic circuitry arranged for generating an emergency call, wherein said circuitry is attached to said structure;
a back-up battery, being an aluminum type battery and electrically connected to said electronic circuitry,
   wherein said aluminum part provides an aluminum electrode of the back-up-battery.

In one or more embodiments, the wording “structure” refers to a frame or a container or a housing. In one or more embodiments, the aluminum part is at least substantially made of aluminum. In one or more embodiments, the electronic circuitry comprises printed circuit boards, sensors and/or software. In one or more embodiments, the circuitry is attached directly or indirectly to the structure, for example by screws or glue.

In one or more embodiments, the back-up battery is an aluminum-air type battery, in which electricity is produced by a reaction of oxygen in air with aluminum.

According to the invention, the aluminum part of the structure of the eCall-system provides the aluminum electrode for this reaction. Therefore, the back-up battery does not need to comprise an aluminum electrode of its own and may therefore be lighter.

In one or more embodiments, said electronic circuitry is further arranged for detecting an accident and for generating said emergency call in response to a detected accident.

In one or more embodiments, the electronic circuitry is further arranged for receiving information from an airbag system, wherein the information indicates that an airbag of the airbag system has been inflated or activated (indicating thus that an accident has been detected) and wherein in response to said information, the electronic circuitry is arranged for generating said emergency call.

In one or more embodiments, said back-up battery comprises an electrolyte in an electrically isolated container, and said back-up battery is arranged for releasing said electrolyte from said container in response to a detected accident in order to activate said back-up battery.

In one or more embodiments, the electrolyte is a fluid (such as water in which one or more salts have been dissolved), a solid matter (such as a powder) or a gas (such as air).

Because the electrolyte is only released inside the back-up battery in case of a detected accident, the back-up battery will leak or lose significantly less energy during the time span up to the accident. This means a reduced required additional capacity and a reduced extra weight.

In one or more embodiments, the eCall-system further comprises an antenna unit comprising a copper part, wherein said copper part provides the copper electrode of the back-up-battery. Therefore, the back-up battery does not need to comprise a copper electrode of its own and may therefore be less heavy. In one or more embodiments, the copper part is at least substantially made of copper.

According to a second aspect, a vehicle comprising an e-Call system is provided comprising an eCall-system as described in this document.

The working, advantages and embodiments of a vehicle according to invention correspond with the working, advantages and embodiments of the eCall-system as described in this document, mutatis mutandis.

### BRIEF DESCRIPTION OF THE DRAWINGS

For a more complete understanding of the present invention, reference in the following description is made to the accompanying drawings in which:

FIGS. 1a and 1b show a schematic overview of one or more embodiments of the eCall-system according to the invention before and after a detected accident, respectively;

FIG. 2 shows a schematic overview of one or more embodiments of a vehicle with an eCall-system according to the invention.

### DETAILED DESCRIPTION

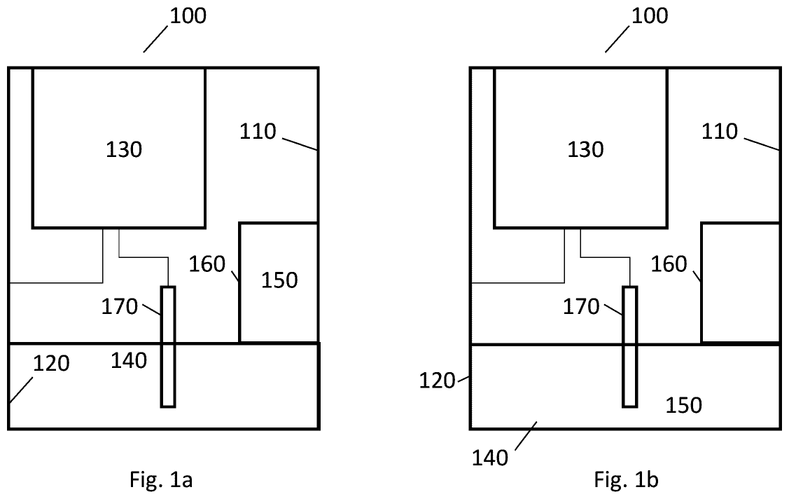

FIG. 1a shows an eCall-system 100 for a vehicle 210 which comprises a structure 110, an electronic circuitry 130 and a back-up battery 140. The relative dimensions of the various features in FIGS. 1a and 1b are not to scale for clarity reasons, i.e. the size of the electronic circuitry 130 may be much larger than the size of the back-up battery.

The electronic circuitry 130 is attached to structure 110. The structure 110 has an aluminum part 120, which forms an electrode 120 of the back-up battery 140. The electronic circuitry 130 is electrically connected to the back-up battery 140 as indicated in FIGS. 1a and 1b.

In one or more embodiments, the back-up battery 140 further comprises an electrode 170, which may be a copper electrode 170. In one or more embodiments, the copper electrode 170 is provided by an antenna unit, which may be part of the eCall-system 100. In general, the electrodes may comprise various suitable metals as is known in the art.

In one or more embodiments, the back-up battery 140 further comprises a container 160, which may contain an electrolyte 150. The electrolyte is inside the container 160 is electrically isolated from the electrodes 120 and 170. This is seen in FIG. 1a. Since the electrolyte is not present between the electrodes 120 and 170, the energy leakage in the back-up battery will be reduced.

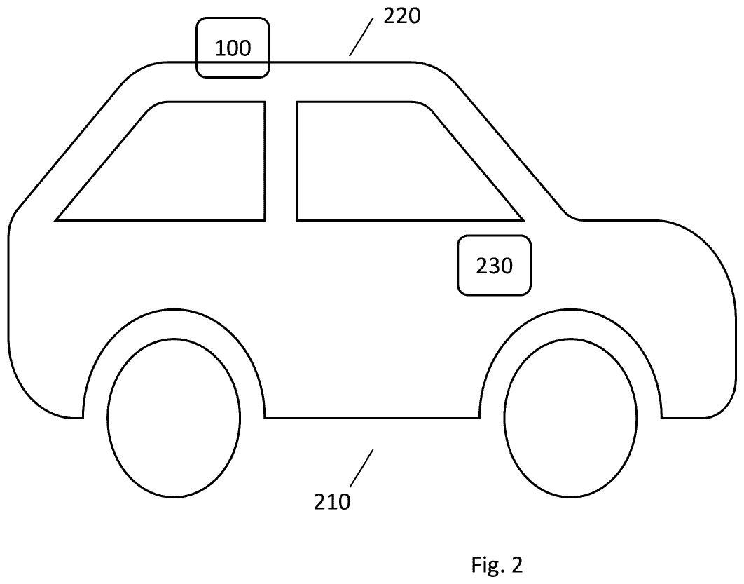

In FIG. 2, a vehicle 210 is depicted with an eCall-system 100 as described with reference to FIGS. 1a and 1b. In one or more embodiments, the eCall-system 100 comprises an antenna unit and may thus be arranged on, in and/or under the roof 220 of vehicle 210.

In one or more embodiments, the electronic circuitry 130 is arranged for detecting an accident with vehicle 210 and for generating an emergency call in response to a detected accident. An accident with vehicle 210 may be detected when an airbag of vehicle 210 is activated or inflated. An airbag system 230, comprising this airbag, may be arranged for transmitting information that an airbag of vehicle 210 is activated. In response to this information, the electronic circuitry 130 may be arranged for generating an emergency call to the local emergency services.

In one or more embodiments, the back-up battery 140 is arranged for releasing electrolyte 150 from container 160 in response to a detected accident, for example in response to the information from the airbag system 230 indicating that an airbag of vehicle 210 was activated.

FIG. 1b depicts the situation in which the electrolyte 150 has been released from container 160 and is now present between the electrodes 120 and 170. This activates the back-up battery 140, which is now ready for use. This means it can provide a back-up power in case the main battery of vehicle 210 is not able to provide the power to the electronic circuitry 130.

In one or more embodiments, the vehicle 210 may be a car, a motorbike, a van, a truck, a bicycle or a scooter.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention.

Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms.

1. An eCall system for a vehicle, the system comprising:
a structure comprising an aluminum part;
an electronic circuitry arranged for generating an emergency call, wherein said circuitry is attached to said structure;
a back-up battery, being an aluminum type battery and electrically connected to said electronic circuitry;
wherein said aluminum part provides an aluminum electrode of the back-up-battery; and
an antenna unit comprising a copper part, wherein said copper part provides a copper electrode of the back-up-battery.

2. The eCall system according to claim 1, wherein said electronic circuitry is further arranged for detecting an accident and for generating said emergency call in response to a detected accident.

3. The eCall system according to claim 2, wherein said back-up battery comprises an electrolyte in an electrically isolated container, and wherein said back-up battery is arranged for releasing said electrolyte from said container in response to a detected accident in order to activate said back-up battery.

4. (canceled)

5. A vehicle including an eCall system, the eCall system comprising:
a structure comprising an aluminum part;
an electronic circuitry arranged for generating an emergency call, wherein said circuitry is attached to said structure;
a back-up battery, being an aluminum type battery and electrically connected to said electronic circuitry;
wherein said aluminum part provides an aluminum electrode of the back-up-battery; and
an antenna unit comprising a copper part, wherein said copper part provides a copper electrode of the back-up-battery.

6. The vehicle according to claim 5, wherein said electronic circuitry is further arranged for detecting an accident and for generating said emergency call in response to a detected accident.

7. The vehicle according to claim 6, wherein said back-up battery comprises an electrolyte in an electrically isolated container, and wherein said back-up battery is arranged for releasing said electrolyte from said container in response to a detected accident in order to activate said back-up battery.
